(19) United States
(12) Patent Application Publication
(10) Pub. No.: US 2023/0175678 A1
(43) Pub. Date: Jun. 8, 2023

(54) ANTI-LOOSENING LIGHT DEVICE

(71) Applicant: DONGGUAN CITY MINLEON ELECTRONICS CO., LTD., Guangdong (CN)

(72) Inventor: Dongchang Chen, Guangdong (CN)

(73) Assignee: DONGGUAN CITY MINLEON ELECTRONICS CO., LTD., Guangdong (CN)

(21) Appl. No.: 17/723,450

(22) Filed: Apr. 18, 2022

(30) Foreign Application Priority Data
Dec. 7, 2021 (CN) 202123060778.6

(51) Int. Cl. F21V 23/06; H01R 33/22; H01R 13/622; H01R 13/627; H01R 13/642

(52) U.S. Cl. CPC F21V 23/06; H01R 33/22; H01R 13/622; H01R 13/6277; H01R 13/642

(57) ABSTRACT

An anti-loosening light device includes a light bulb and a light socket. One end of the light bulb is screwed into the light socket and is detachably connected to the light socket. The light bulb includes a bulb head and a bulb body. The bulb head is connected to the bulb body. The bulb body is provided with a bulb body positioning part. The bulb body positioning part is connected to the light socket. The light socket includes a socket body and socket limiting parts. The socket limiting parts are connected to the socket body. One end of the light bulb is inserted into the socket body. The bulb body positioning part is installed on the socket limiting parts. The bulb body positioning part and the socket limiting parts are engaged with each other.

### CROSS-REFERENCE TO RELATED APPLICATION

This application claims the priority benefit of China application serial no. 202123060778.6, filed on Dec. 7, 2021. The entirety of the above-mentioned patent application is hereby incorporated by reference herein and made a part of this specification.

### BACKGROUND

### Technical Field

The disclosure relates to the technical field of lamps, and in particular to an anti-loosening light device.

### Description of Related Art

In the prior art, the light bulb and the light socket are fixed by screw connection or snap connection, but such fixations have the following defects. The connection between the light bulb and the light socket is not stable enough. After long-term use, the light bulb may easily loosen and fall from the light socket, resulting in a reduction in the service life of the light bulb, and safety hazard when the light bulb falls from a high place.

### SUMMARY

The disclosure provides an anti-loosening light device, which have a more stable connection between the light bulb and the light socket and is not easy to loosen to improve the service life of the light bulb and improve safety, so as to solve the issues raised in the “Description of Related Art” section.

To achieve the above objectives, the disclosure provides the following technical solutions.

The disclosure provides an anti-loosening light device, which includes a light bulb and a light socket. One end of the light bulb is screwed into the light socket and is detachably connected to the light socket. The light bulb includes a bulb head and a bulb body. The bulb head is connected to the bulb body. The bulb body is provided with a bulb body positioning part. The bulb body positioning part is connected to the light socket.

The light socket includes a socket body and socket limiting parts. The socket limiting parts are connected to the socket body. One end of the light bulb is inserted into the socket body. The bulb body positioning part is installed on the socket limiting parts. The bulb body positioning part and the socket limiting parts are engaged with each other.

According to an embodiment of the disclosure, the bulb body positioning part is a sawtooth positioning buckle. The sawtooth positioning buckle has a ring shape, is disposed on a top part of the bulb body, and is fixedly connected to the bulb body. Sawtooth portions of the sawtooth positioning buckle are inclined relative to a radial direction of the sawtooth positioning buckle.

According to an embodiment of the disclosure, a side surface of the bulb head is provided with a threaded positioning part. The threaded positioning part is connected with a positioning platform.

According to an embodiment of the disclosure, the socket limiting parts form a limiting seat of the light socket. The limiting seat of the light socket has a ring shape, is disposed on an inner wall of the socket body, and is connected to the socket body. The socket limiting parts are inclined relative to a radial direction of the limiting seat. An inclined direction of the socket limiting parts is opposite to an inclined direction of the sawtooth portions of the sawtooth positioning buckle. The limiting seat of the light socket and the sawtooth positioning buckle are engaged with each other.

According to an embodiment of the disclosure, an inner side of the socket body is connected with an arc-shaped positioning seat. The threaded positioning part is installed on the arc-shaped positioning seat.

According to an embodiment of the disclosure, an inner side of the socket body is provided with a positioning groove. The positioning platform is installed in the positioning groove.

Compared with the prior art, the beneficial effects of the disclosure are as follows.

After the light bulb of the disclosure is inserted into the light socket, since the inclined direction of the limiting seat of the light socket is opposite to the sawtooth positioning buckle, and the limiting seat of the light socket and the sawtooth positioning buckle are engaged with each other to form a state of mutual hugging, the connection between the light bulb and the light socket is more stable and not easy to loosen, which improves the service life of the light bulb and improves safety.

### BRIEF DESCRIPTION OF THE DRAWINGS

FIG. 1 is a schematic structural view of the disclosure.

FIG. 2 is an exploded view of the disclosure.

FIG. 3 is a schematic structural view of a light socket of the disclosure.

FIG. 4 is a schematic structural view of a light bulb of the disclosure.

FIG. 5 is a schematic structural view of the light bulb of the disclosure in another direction.

FIG. 6 is a schematic structural view of the light bulb and the light socket of the disclosure in a disengaged state.

FIG. 7 is a schematic structural view of the light bulb and the light socket of the disclosure in an engaged state.

### DETAILED DESCRIPTION OF DISCLOSED EMBODIMENTS

The technical solutions in the embodiments of the disclosure will be clearly and completely described below with reference to the accompanying drawings in the embodiments of the disclosure. Obviously, the described embodiments are only a part of the embodiments, rather than all of the embodiments, of the disclosure. Based on the embodiments of the disclosure, all other embodiments obtained by persons skilled in the art without innovative effort fall within the protection scope of the disclosure.

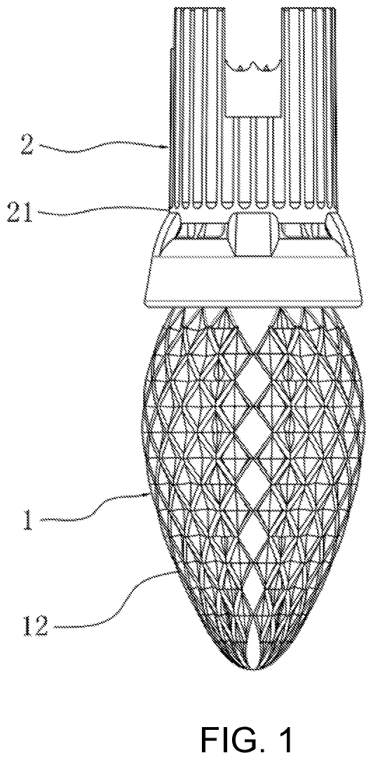

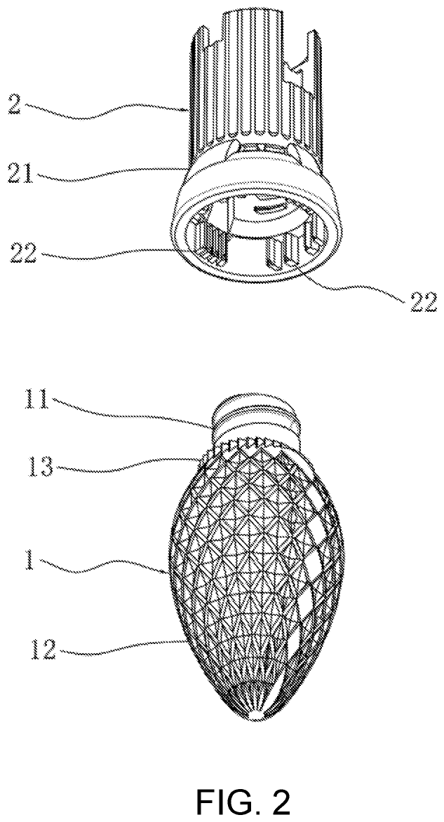

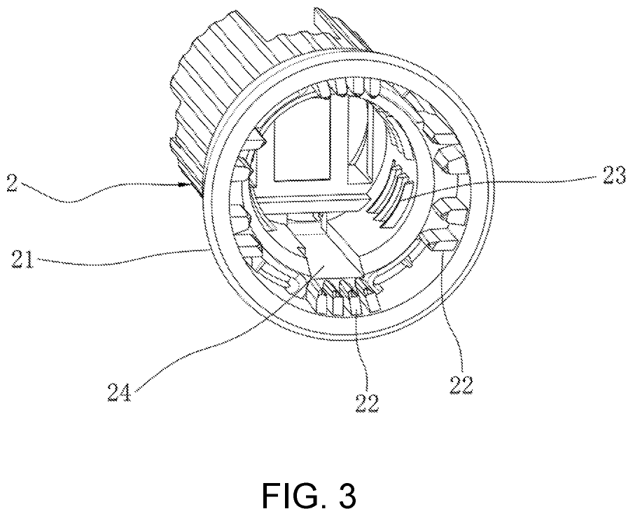

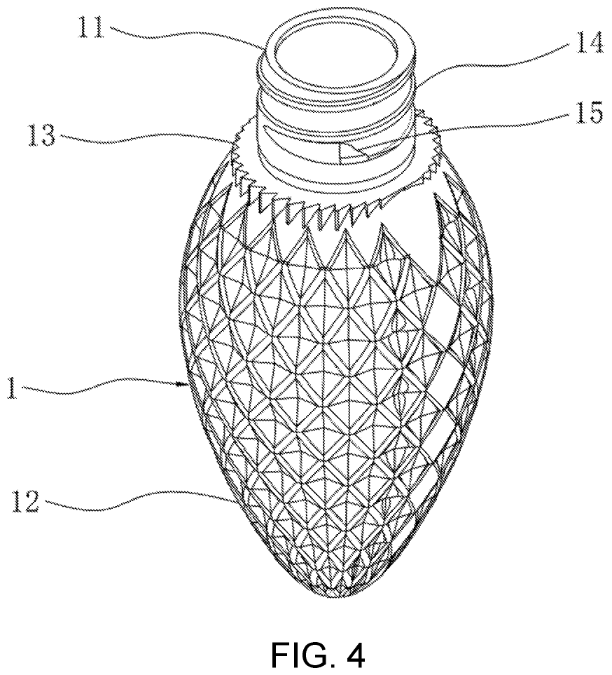

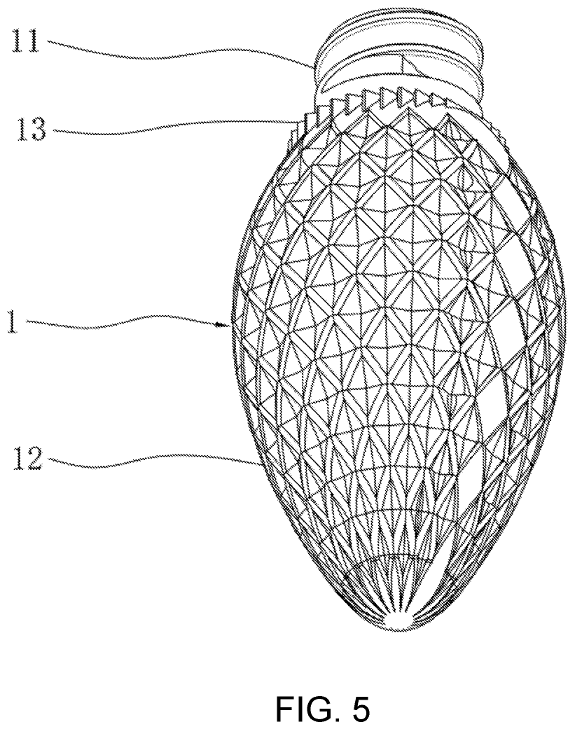

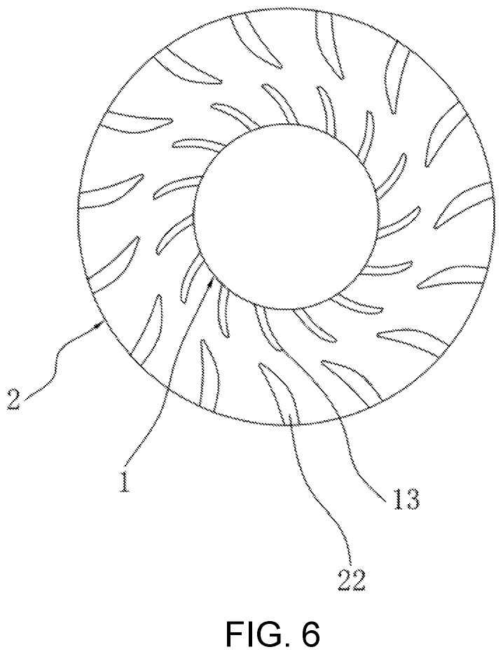

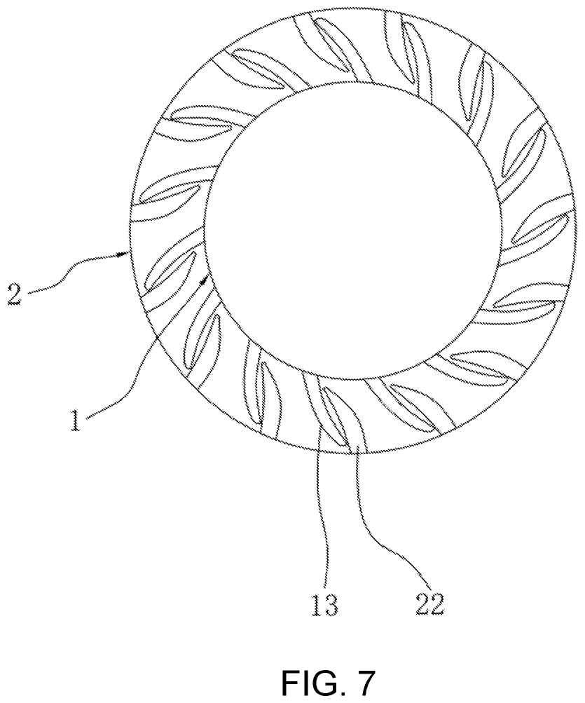

Please refer to FIG. 1 to FIG. 7. In the embodiment of the disclosure, please refer to FIG. 1 for an anti-loosening light device, which include a light bulb 1 and a light socket 2. One end of the light bulb 1 is screwed into the light socket 2 and is detachably connected to the light socket 2. The light bulb 1 includes a bulb head 11 and a bulb body 12. The bulb head 11 is fixedly connected to the bulb body 12. The bulb body 12 is provided with a bulb body positioning part 13. The bulb body positioning part 13 and the light socket 2 are engaged with each other. Further, please refer to FIG. 4 and FIG. 5. The bulb body positioning part 13 is a sawtooth positioning buckle. The sawtooth positioning buckle has a ring shape, is disposed on a top part of the bulb body 12, and is fixedly connected to the bulb body 12. Sawtooth portions of the sawtooth positioning buckle 13 are inclined relative to a radial direction of the sawtooth positioning buckle 13. Please refer to FIG. 2 and FIG. 3. The light socket 2 includes a socket body 21 and socket limiting parts 22. The socket limiting parts 22 are fixedly connected to the socket body 21. One end of the light bulb 1 is inserted into the socket body 21. The bulb body positioning part 13 is installed on the socket limiting parts 22, and the bulb body positioning part 13 and the socket limiting parts 22 are engaged with each other. Further, please refer to FIG. 3 and FIG. 6. The socket limiting parts 22 form a limiting seat of the light socket 2. The limiting seat of the light socket 2 has a ring shape, is disposed on an inner wall of the socket body 21, and is fixedly connected to the socket body 21. The socket limiting parts 22 are inclined relative to a radial direction of the limiting seat. Please refer to FIG. 7. An inclined direction of the socket limiting parts is opposite to an inclined direction of the sawtooth portions of the sawtooth positioning buckle 13. The limiting seat of the light socket 2 and the sawtooth positioning buckle 13 are engaged with each other, so that the connection is more stable. After the light bulb 1 of the disclosure is inserted into the light socket 2, since the inclined direction of the socket limiting parts 22 is opposite to the inclined direction of the sawtooth portions of the sawtooth positioning buckle 13, and the limiting seat of the light socket 2 and the sawtooth positioning buckle 13 are engaged with each other to form a state of mutual hugging, the connection between the light bulb 1 and the light socket 2 is more stable and not easy to loosen, which improves the service life of the light bulb 1 and improves safety.

In a preferred embodiment of the disclosure, a side surface of the bulb head 11 is provided with a threaded positioning part 14. The threaded positioning part 14 is fixedly connected with a positioning platform 15.

In a preferred embodiment of the disclosure, an inner side of the socket body 21 is connected with an arc-shaped positioning seat 23. The threaded positioning part 14 is installed on the arc-shaped positioning seat 23, thereby fixing the bulb head 11 in the socket body 21. Further, the inner side of the socket body 21 is provided with a positioning groove 24. The positioning platform 15 is installed in the positioning groove 24, so that the connection between the bulb head 11 and the socket body 21 is more stable.

After the light bulb 1 of the disclosure is inserted into the light socket 2, since the inclined direction of the socket limiting parts 22 is opposite to the inclined direction of the sawtooth portions of the sawtooth positioning buckle 13, and the limiting seat of the light socket 2 and the sawtooth positioning buckle are engaged with each other to form a state of mutual hugging, the connection between the light bulb 1 and the light socket 2 is more stable and not easy to loosen, which improves the service life of the light bulb 1 and improves safety.

Although the disclosure has been described in detail with reference to the foregoing embodiments, for persons skilled in the art, it is still possible to modify the technical solutions described in the foregoing embodiments or equivalently replace some of the technical features. Any modification, equivalent replacement, improvement, etc. made within the spirit and principle of the disclosure shall be included within the protection scope of the disclosure.

1. An anti-loosening light device, comprising a light bulb and a light socket, wherein one end of the light bulb is screwed into the light socket and is detachably connected to the light socket, the light bulb comprises a bulb head and a bulb body, the bulb head is connected to the bulb body, the bulb body is provided with a bulb body positioning part, the bulb body positioning part is a sawtooth positioning buckle formed on circumference of the bulb body, the sawtooth positioning buckle comprises a plurality of sawtooth portions erected from the bulb body, and the sawtooth portions of the sawtooth positioning buckle are inclined with respect to a radial direction of the bulb body; and
the light socket comprises a socket body and a limiting seat formed on an inner wall of the socket body, the limiting seat comprises a plurality of socket limiting parts erected from the inner wall of the socket body and inclined with respect to a radial direction of the socket body, wherein the sawtooth portions and the socket limiting parts are configured to engaged with each other when the light bulb is screwed into the light socket, and the bulb body is fitted into the socket body, to resist the bulb body from departing from the socket body.

2. (canceled)

3. The anti-loosening light device according to claim 1, wherein a side surface of the bulb head is provided with a threaded positioning part, the threaded positioning part is connected with a positioning platform.

4. (canceled)

5. The anti-loosening light device according to claim 3, wherein an inner side of the socket body is connected with an arc-shaped positioning seat, and the threaded positioning part is installed on the arc-shaped positioning seat.

6. The anti-loosening light device according to claim 3, wherein an inner side of the socket body is provided with a positioning groove, and the positioning platform is installed in the positioning groove.
